(19) United States
(12) Patent Application Publication
(10) Pub. No.: US 2011/0199334 A1
(43) Pub. Date: Aug. 18, 2011

(54) RESISTIVE-FILM-BASED TOUCH-SENSITIVE SHEET, TOUCH-SENSITIVE PANEL, AND MANUFACTURING METHOD THEREOF

(75) Inventors: HyunHa Hwang, Seoul (KR); SeungGon Kang, Hwaseong-si (KR); JungHwan Yoon, Suwon-si (KR)

(73) Assignee: IMAGELAB CO., LTD., Ansan-si (KR)

(21) Appl. No.: 13/124,359

(22) PCT Filed: Sep. 8, 2009
(86) PCT No.: PCT/KR2009/005086

§ 371 Date: Apr. 14, 2011

(30) Foreign Application Priority Data
Oct. 17, 2008 (KR) 10-2008-0102010
Apr. 20, 2009 (KR) 10-2009-0034035

(51) Int. Cl. G06F 3/045; B32B 37/02; B32B 37/12; B32B 38/00; B32B 38/14

(52) U.S. Cl. 345/174; 156/275.5; 156/322; 156/281; 156/277

(57) ABSTRACT

The present invention relates to a resistive-film-based touch-sensitive sheet, touch-sensitive panel, and manufacturing method thereof. Embodiments of the invention provide a touch-sensitive sheet used for manufacturing a resistive-film type touch panel that includes: a base film; a transparent insulative adhesive film, in which conductive balls are mixed, located over the base film; and a releasing paper adhered over the transparent insulative adhesive film, as well as an integrated type touch-sensitive sheet that includes: an upper board for a touch panel; an upper contact electrode patterned on the upper board; a transparent insulative adhesive film, in which conductive balls are mixed, located over the upper board and the upper contact electrode; and a releasing paper adhered over the transparent insulative adhesive film.

### CROSS-REFERENCE TO RELATED APPLICATIONS

This application is the National Phase of PCT/KR2009/005086 filed on Sep. 8, 2009, which claims priority under 35 U.S.C. 119(a) to Patent Application No. 10-2008-0102010 filed in the Republic of Korea on Oct. 17, 2008, and to Patent Application No. 10-2009-0034035 filed in the Republic of Korea on Apr. 20, 2009, all of which are hereby incorporated by reference into the present application.

### BACKGROUND

1. Technical Field

The present invention relates to a resistive-film-based touch-sensitive sheet, touch-sensitive panel, and manufacturing method thereof. More particularly, the invention relates to a resistive-film-based touch-sensitive sheet that has an adhesive which contains ball spacers and conductive balls and is coated over the entire surface, as well as to the touch panel, and manufacturing method.

2. Description of the Related Art

With advances in mobile communication technology, electronic information terminals such as cell phones, PDA's, and navigation systems have become more than means for displaying simplistic text, expanding their range of functions to providing a variety of complicated multimedia contents such as audio, video, wireless Internet browser, etc. Thus, there is a demand for implementing larger display screens within the limited size of the electronic information terminal, and as such, the display method employing a touch-sensitive screen is receiving much acclaim.

The touch-screen display device, in which a touch screen superimposed over the display element, integrates the screen with a means for inputting coordinates, making it possible to save space compared to the conventional key-input method. As the electronic information terminal to which a touch-screen display device is applied can thus increase both screen size and user convenience, the use of this method is on an increasing trend.

Touch panels include the resistive-film type, capacitive type, etc., among which the resistive-film type is described as follows. FIG. 1 is a cross-sectional view of a resistive-film type touch panel according to the related art, and FIG. 2 is a cross-sectional view of a touch-screen display device that uses a resistive-film type touch panel according to the related art.

In a resistive-film type touch panel 10 according to the related art, an adhesive 15 such as double-sided tape, etc., is used to attach the edges between the upper plate 11 and upper contact electrode 13 and the lower plate 19 and lower contact electrode 17. Therefore, an air gap 300 is formed in the area excluding the attached portions at the edges, as illustrated in FIG. 1, and a number of dot spacers 21 are formed on the lower contact electrode 17. As illustrated in FIG. 1, in such a resistive-film type touch panel 10 according to the related art, scattered reflection 110 occurs due to the air gap 300 formed between the upper plate 11 and the lower plate 19 when external incident light 100 enters, and scattered reflection 210 occurs also when internal light 200 emitted from the display device is radiated outward. Also, since only the edge portions of the upper plate 11 and upper contact electrode 13 and the lower plate 19 and lower contact electrode 17 are joined by an adhesive 15 such as double-sided tape, etc., there may not be a uniform distance between the upper plate 11 and the lower plate 19 at the center portion and the edge portions.

FIG. 2 is a cross-sectional view of an example in which a resistive-film type touch panel according to the related art is attached to a liquid crystal display element, and it can be seen that an air gap 300 is created in the area excluding the edges when the touch panel 10 and the liquid crystal display element 50 are attached at the edge portions by an adhesive 15 such as double-sided tape, etc., as illustrated in FIG. 2. The structure of the liquid crystal display element 50 includes an upper transparent plate 33, which has an upper polarizing plate 31, attached to a lower transparent plate 37, which has a lower polarizing plate 39, with liquid crystal 35 injected into the attached space between the two plates, and a backlight unit 43 mounted on a lower portion of the lower transparent plate 37.

As illustrated in FIG. 1 and FIG. 2, the air gap 300 present in the resistive-film type touch panel 10 as well as the air gap 300 created when it is attached to a liquid crystal display device 50 may cause external light 100 to reach the display element or may create scattered reflection 110, 210 when the light emitted from the backlight unit 43 is radiated outward, and such scattered reflection may lower transmittance. While this decline in transmittance can be compensated by increasing the luminous intensity of the backlight unit, this may cause an increase in power consumption.

In cases where a resistive-film type touch panel is externally attached to a liquid crystal display element, as in the composition shown in FIG. 2, the overall thickness may be increased. To resolve this problem, Korean Patent Publication No. 10-2007-120694 teaches an example in which a touch-panel contact electrode is formed between the upper polarizing plate and the upper transparent plate that form the liquid crystal display element. That is, the example in FIG. 3 can reduce the overall thickness, as the touch-sensitive lower contact electrode 17 is formed directly on the upper board 33 of the liquid crystal display element.

FIG. 3, which has been disclosed in Korean Patent Publication No. 10-2007-120694, is a drawing of a touch-panel-integrated display device according to the related art that has a touch-sensitive contact electrode between the upper polarizing plate 31 and the upper transparent plate 33. In the example of FIG. 3 also, an air gap 300 is present in the touch panel, between the lower contact electrode 17 and the upper contact electrode 13, causing the problem of scattered reflection.

Furthermore, with the air gap formed between upper plate and lower plate of the touch panel and with the air gap created at the attached portions of the touch panel and liquid crystal display element, since only the edge portions are secured by an adhesive such as double-sided tape, etc., there are many occurrences in which the attached distance at the screen area excluding the edges is not uniform. The upper plate of the touch panel, in particular, has to be formed from a transparent plastic such as common PET, because it is the portion which the user touches, but distance inconstancy frequently occurs compared to using a transparent glass plate, and there are many occurrences of degraded display properties, such as the occurrences of Newton rings, in the surrounding portions when a user presses the upper plate.

### SUMMARY

To resolve certain problems such as those described above, an aspect of the present invention is to provide a resistive-film type touch-sensitive sheet, touch panel, and manufacturing method thereof, with which the air gap areas formed between the upper plate and lower plate of the touch panel are removed.

The objective above can be achieved by a touch-sensitive sheet used for manufacturing a resistive-film type touch panel that includes: a base film; a transparent insulative adhesive film, in which conductive balls are mixed, located over the base film; and a releasing paper adhered over the transparent insulative adhesive film.

Another objective of the invention can be achieved by a method of manufacturing a touch-sensitive sheet used for manufacturing a resistive-film type touch panel, where the method includes: a first step of forming a base film; a second step of forming a transparent insulative adhesive material, in which conductive balls are mixed, over the base film; a third step of curing the transparent insulative adhesive material using heat or UV rays; and a fourth step of adhering a releasing paper over the transparent insulative adhesive film.

Another objective of the invention can be achieved by a touch-screen display device in which a resistive-film type touch panel is mutually attached and coupled on one surface to a display element that displays images to the user, where the display element and the resistive-film type touch panel are attached over an entire surface by a transparent adhesive, in which balls spacers are mixed in so as to keep a uniform distance between the display element and the resistive-film type touch panel.

With a resistive-film type touch panel according to an aspect of the present invention, a transparent adhesive film containing conductive balls is applied to entirely adhering the upper plate with the lower plate, thereby significantly reducing Newton rings, which may be formed due to discrepancies in distance between the upper plate and lower plate caused by attaching only the edge portions according to the related art.

Since a material having a similar refractive index to that of the upper plate and lower plate of the touch panel is used for the transparent adhesive, scattered reflection caused by air gaps formed in resistive-film type touch panels based on the related art can be minimized. Therefore, the energy consumption involved in increasing the luminous intensity of the backlight to compensate for the decline in transmittance resulting from scattered reflection due to air gaps, as found in the related art, can be reduced.

In a touch panel manufactured using a touch-sensitive sheet according to an aspect of the invention, the upper plate and lower plate may be adhered by an adhesive that is transparent and insulative. Thus, if there is a defect in an area corresponding to certain pixels of the upper plate or lower plate, the upper plate and lower plate may readily be separated, to replace only the portion having the defect while continuing to use the portions free of defects. In other words, whereas, in the case of a resistive-film type touch panel based on the related art, a defect may disable the use of even the display device to which the touch panel is attached, in the case of a resistive-film type touch panel based on an aspect of the present invention, it is possible to replace just the touch-sensitive sheet in which the defect has occurred.

Furthermore, by applying a transparent adhesive in attaching the touch panel to the display element, the distance between the touch panel and the display element can be kept uniform over the entire screen, to thereby minimize the occurrence of Newton rings.

### BRIEF DESCRIPTION OF THE DRAWINGS

FIG. 1 is a cross-sectional view of a resistive-film type touch panel according to the related art.

FIG. 2 is a cross-sectional view of a touch-screen display device that uses a resistive-film type touch panel according to the related art.

FIG. 3 is a cross-sectional view of a touch-panel-integrated display device having a touch panel between an upper polarizing plate and an upper transparent plate as disclosed in Korean Patent Publication No. 10-2007-120694.

FIG. 4 is a cross-sectional view of a resistive-film type touch-sensitive sheet according to an embodiment of the present invention.

FIG. 5 is a cross-sectional view of a resistive-film type touch-sensitive sheet according to an embodiment of the present invention.

FIG. 6 is a cross-sectional view of a resistive-film type plate-integrated touch-sensitive sheet according to an embodiment of the present invention.

FIG. 7 is a flow diagram of a process for manufacturing the resistive-film type touch-sensitive sheet shown in FIG. 4.

FIG. 8 is a process diagram as seen from above.

FIG. 9 is a process diagram as seen as a cross-sectional view across line B-B′ of FIG. 8.

FIG. 10 is a flow diagram of a process for manufacturing the resistive-film type touch-sensitive sheet shown in FIG. 5.

FIG. 11 is a flow diagram of a process for manufacturing the resistive-film type touch-sensitive sheet shown in FIG. 5 as seen as a cross-sectional view.

FIG. 12 is a flow diagram of a process for manufacturing the resistive-film type plate-integrated touch-sensitive sheet shown in FIG. 6.

FIG. 13 is a flow diagram of a process for manufacturing the resistive-film type plate-integrated touch-sensitive sheet shown in FIG. 6 as seen as a cross-sectional view.

FIG. 14 is a flow diagram of a process for manufacturing a touch panel using a touch-sensitive sheet formed by the process shown in FIG. 7.

FIG. 15 is a flow diagram of a process for manufacturing a touch panel using a touch-sensitive sheet formed by the process shown in FIG. 7 as seen as a cross-sectional view.

FIG. 16 is a flow diagram of a process for manufacturing a touch panel using a resistive-film type plate-integrated touch-sensitive sheet formed by the process shown in FIG. 12.

FIG. 17 is a flow diagram of a process for manufacturing a touch panel using a resistive-film type plate-integrated touch-sensitive sheet formed by the process shown in FIG. 12 as seen as a cross-sectional view.

FIG. 18 is a flow diagram of a process for manufacturing a touch panel using a resistive-film type plate-integrated touch-sensitive sheet formed by the process shown in FIG. 12.

FIG. 19 is a flow diagram of a process for manufacturing a touch panel using a resistive-film type plate-integrated touch-sensitive sheet formed by the process shown in FIG. 12 as seen as a cross-sectional view.

FIG. 20 is a flow diagram of a process for manufacturing a touch panel using a plate-integrated touch-sensitive sheet formed by the process shown in FIG. 12 and a lower plate having dot spacers.

FIG. 21 is a flow diagram of a process for manufacturing a touch panel by attaching a plate-integrated touch-sensitive sheet formed by the process shown in FIG. 12 onto a lower plate having dot spacers, as seen as a cross-sectional view.

FIG. 22 is a cross-sectional view of a display device to which a touch-sensitive sheet according to an embodiment of the present invention has been applied.

FIG. 23 is a cross-sectional view of a display device to which a touch-sensitive sheet according to an embodiment of the present invention has been applied.

### DETAILED DESCRIPTION

Certain advantages, features, and preferred embodiments of the present invention are described below in more detail with reference to the appended drawings.

In the several drawings illustrating the invention, those parts that are indicated by the same reference numbers are of substantially the same material and properties and thus redundant descriptions will be omitted.

FIG. 4 is a cross-sectional view of a resistive-film type touch-sensitive sheet according to an embodiment of the present invention. The touch-sensitive sheet 60-1 may be structured to have a base film 61, a transparent insulative adhesive film 25, in which conductive balls 23 and ball spacers 27 are mixed, formed over the base film 61, and a releasing paper 63 adhered over that. The base film 61 may be a film for supporting the adhesive film 25 and may be formed from a thin layer of synthetic resin. Since it is an element that is stripped off after adhering the adhesive film 25 to a transparent plate, the base film 61 itself does not necessarily have to be transparent. The releasing paper 63 may be formed as a thin film that protects the adhesive film 25 from foreign substances, etc., sticking to it. Similar to the base film 61, the releasing paper 63 is an element that is stripped off after adhering the adhesive film 25 to the transparent plate, and therefore does not necessarily have to be transparent.

The transparent insulative adhesive film 25 may be used as a filler filled in between the upper plate and lower plate of a resistive-film type touch panel. The transparent insulative adhesive film 25 is a transparent, insulative film having gel-like properties that contains conductive balls 23 and ball spacers 27 inside and is adhered to the transparent electrodes formed on the upper plate and lower plate. The ball spacers 27 may serve to maintain a uniform thickness for the adhesive film 25, while the conductive balls 23 may enable conduction between the upper contact electrode formed on the upper plate and the lower contact electrode formed on the lower plate, when the user presses the upper plate of the resistive-film type touch panel. The diameter of the ball spacers 27 may be smaller than or equal to the thickness of the adhesive film 25, while the diameter of the conductive balls 23 may be smaller than the diameter of the ball spacers 27.

The transparent insulative adhesive film 25 used in an embodiment of the invention may be electrically non-conductive, and the refractive index of the transparent adhesive 25 may preferably be almost or completely the same as the refractive index of the upper plate and lower plate forming the touch panel. To be almost the same means that the difference in refractive indexes is 0.1 or less.

The transparent insulative adhesive film 25 can be formed by curing an acrylic copolymer or a silicone elastic polymer.

The types of acrylic copolymer that can be used can be divided mainly into UV polymerizable types and UV crosslinkable types. In the case of UV polymerizable acrylic copolymers, the composition concept is substantially the same, and various additives can be mixed in. The basic components may include oligomers, monomers, photoinitiators, fillers having minerals with small diameters, adhesion improvers, etc.

For a photo-radical polymerizable type, the basic properties of the UV adhesive may be determined by the structure of the oligomer. In general, an epoxy acrylate oligomer shows superior heat resistance and chemical resistance, while an urethane acrylate oligomer shows high flexibility and superior adhesion. A general purpose epoxy acrylate oligomer may contain high amounts of chloride ions and may therefore be apt to result in electrolytic corrosion. Monomers may include acrylate compounds and methacrylate compounds, and the main skeleton may be divided into aromatic and aliphatic types. An aliphatic structure may be used when the optical properties are important. The number of functional groups may range from 1 to 6, to be used in adjusting viscosity or providing flexibility. A greater number of functional groups may be advantageous in terms of curing speed, heat resistance, and outgas generation properties, but may likely degrade adherence. Methacrylate compounds for UV adhesion purposes are seldom used, due to its inferior surface curing properties resulting from the inhibition of oxygen. A photo-radical polymerization initiator may act as a catalyst during the polymerization of acrylate oligomers or monomers, etc. Two types include one type that absorbs and emits hydrogen and the open-radical type, where the open-radical type has a higher reactivity and is more suited for adhesive purposes. Absorption in the long-wave range may provide superior results in terms of curing speed but may provide insufficient surface curing.

In the case of a UV polymerizable acrylic copolymer adhesive, it may be preferable to include at least one oligomer selected from urethane, epoxy, and polyester, at 45 to 85 weight %; at least one monomer selected from acrylic acid, 2-hydroxyethyl methacrylate, and glycidyl methacrylate, at 10 to 50 weight %; a photoinitiator at 1 to 5 weight %; and at least one additive selected from polyvinyl alcohol and sodium alginate at 0.01 to 2 weight %.

For a photo-cationic polymerizable type, the main ingredient of the base material oligomer is epoxy resin, and the basic properties of the UV adhesive may be determined by the molecular structure. Generally used is the bisphenol type epoxy resin, which is characterized by superior heat resistance, adherence, strength, and chemical resistance, but which entails high viscosity and slow curing. The monomers may include vinyl ester compounds, oxetane compounds, polyol compounds, etc., used jointly in addition to the epoxy compound, and these may control viscosity or provide plasticity. Problems may include high volatility and high absorption. Epoxy monomers can provide higher reliability when they have lower volatility and high reactivity. Many epoxy monomers synthesized from epichlorohydrin have a high chlorine content. A photo-cationic polymerization initiator may act as a catalyst for polymerizing epoxy resin, epoxy monomers, etc. There are not many photo-cationic polymerization initiators that have been put into general use. Initiators for anions mainly include SbF6 and PF6 aromatic polyester salts and aromatic iodide salts. SbF6 aromatic sulfonium salts readily provide heat resistance and high adhesion, but they are poorly soluble and are poisonous. PF6 aromatic sulfonium salts are non-poisonous and readily provide high transparency, but they have low reactivity and may degrade heat resistance. Aromatic iodide salts may provide increased curing speed when used jointly with a sensitizer, but they are prone to coloring and their absorption is low for the long-wave range. The high the content of a photo-cationic polymerization initiator, the more exacerbated may be the problems related to moisture resistance and outgas generation. If the content is too low, the effect of moisture may readily degrade surface curing.

A photoinitiator is a material that is added to a UV resin (this term is used here to refer collectively to all types of paint, coating, ink, varnish, colorant, sealant, etc., that use UV rays) to absorb energy from a UV lamp to initiate a polymerization reaction. While it may vary according to resin type, a photoinitiator may be included to about 0.1 to 5% and may serve to initiate photopolymerization by applying the energy required by monomers, oligomers, and free radicals for photopolymerization and, after these materials are cured, turning them into polymer materials. Methods of curing the UV resin may be divided according to the curing mechanism into free radical polymerization and cationic polymerization, where most types of varnish currently used are from free radical polymerization. Free radical polymerization may be divided into intermolecular hydrogen abstraction types and intramolecular photocleavage types. Intermolecular hydrogen abstraction types include benzophenone groups and thioxanthone groups. An intermolecular hydrogen abstraction type actually cannot participate in photopolymerization by itself, and instead causes a polymerization reaction together with a hydrogen donor (for which tertiary amines are mainly used).

Intermolecular hydrogen abstraction types involve the molecules themselves absorbing UV energy to form radicals, and are used the most in UV resins. The most representative examples include α-hydroxy ketones, which are mainly used in transparent coatings; α-amino ketones, which are suitable for colored coatings; and BDK, etc. Recent times have also seen the use of phenyl glyoxylates for transparent coatings, aryl phosphine oxides for white coatings and finishings, and so on. The mixed ratio of the photoinitiator may vary considerably according to the applied usage and facilities, but in transparent coatings, 2 to 5% is generally used.

In the case of a UV crosslinkable acrylic copolymer adhesive material, at least one acrylate monomer selected from 2-ethylhexyl acrylate (2-EHA), vinyl acetate (VAC), and 2-hydroxyethyl methacrylate (2-HEMA), at 45 to 80 weight %; a C-36 photoinitiator (polymerizable double bond containing benzophenone derivative) at 15 to 50 weight %; an initiator of 2,2-azobisisobutyronitrile (AIBN) at 1 to 5 weight %, and ethyl acetate (Duksan Pure Chemical Co.) at 0.01 to 2 weight % can be used.

A silicon elastic polymer may be composed of a main component, which matches the insulative, transmissive, and refractive properties; a side component, which adjusts the adhesive strength; and a curing agent. At least one material selected from silicate resin, siloxane polymers, dimethyl siloxane, dimethylvinyl-terminated, dimethylvinyl group trimethyl silica, and tetrasilane, which provide a sticky quality, may be used for the main component. A hydrocarbon solvent may be used for the main component, and thermal stability additives can be selectively added. At least one selected from dimethyl, methyl hydrogen siloxane, dimethly siloxane, dimethylvinyl-terminated, and dimethyvinylated silica and trimethylated silica, tetramethyl tetravinyl cyclotetrasiloxane may be used for the curing agent.

The transparent insulative adhesive film 25 used in an embodiment of the invention may serve to adhere the transparent electrodes of the upper plate and lower plate forming the touch panel. By using this adhesive film, the problem of separation between the upper plate and the adhesive film as well as the bubbles created therefrom, when the user touches the upper plate many times, can be resolved. Also, since the manufacturing process allows for a sheet form, the process for manufacturing the touch panel can be simplified. When a defect occurs, such as of the transparent conductive film breaking at a portion of the upper plate or lower plate forming the touch panel, the plate in which the defect has occurred can be removed and replaced.

It was found that the adhesive strength of the transparent insulative adhesive film 25, according to the ASTM D3330 measurement standards, satisfying the above functions has to be kept at 50 to 10,000 gf/in. If the adhesive strength is below 50 gf/in, the upper contact electrode formed on the upper plate of the touch panel may become detached from the transparent insulative adhesive film 25 when there is frequent touching. There is no significant problem if the adhesive strength of the transparent insulative adhesive film 25 is high, but when a defect occurs in a portion of the touch electrode, it may be necessary to separate the upper plate and lower plate of the touch panel for reworking, and if the adhesive strength of the transparent insulative adhesive film exceeds 10,000 gf/in, the separating work may become more difficult.

The conductive balls 23 may serve to enable conduction between the transparent electrodes formed on the upper contact electrode formed on the upper plate and the lower contact electrode, when the user presses the upper plate of the touch panel. The conductive balls 23 may be of carbon fiber, metal (Ni, solder), or metal-coated (Ni, Au) polymer types, etc., among which metal-coated polymers are widely used. The conductive balls 23 having a structure of metal coated over polymers may be produced by coating Ni (0.1 μm) and Au (0.05 μm) in order over a polymer spacer core and are the most widely used. It may be desirable if the conductive balls 23 are transparent, but coating a metal on the surfaces may provide an opaque quality. However, even when the conductive balls 23 are opaque, the concentration of the conductive balls present within the transparent adhesive is not that high and does not greatly affect the overall transmittance.

While an example is illustrated in which ball spacers 27 and conductive balls 23 are mixed into the transparent insulative adhesive film 25, it is just as well possible to use dot spacers instead of ball spacers 27, and in the case of a touch-sensitive sheet 60-1 that is to be used in a smaller-sized touch panel, it may be possible to use the conductive balls 23 without mixing in the ball spacers 27 or dot spacers.

A transparent insulative adhesive film 25 cured after using the transparent insulative adhesive material of the following example has been found to have an adhesive strength equal to or greater than 50 gf/in according to the ASTM D3330 measurement standards.

1. Composition Example of a UV Polymerizable Acrylic Copolymer Transparent Insulative Adhesive Material

| Component | Example | | | | |
|---|---|---|---|---|---|
| (Weight %) | 1 | 2 | 3 | 4 | 5 |
| Oligomer | 70.0 | 75.0 | 77.0 | 60.0 | 65.0 |
| Monomer | 25.0 | 20.0 | 18.0 | 35.0 | 30.0 |
| Photoinitiator | 3.0 | 4.0 | 3.5 | 4.5 | 3.0 |
| Solvent | 2.0 | 1.0 | 1.5 | 0.5 | 2.0 |

Urethane was used for the oligomer, 2-hydroxyethyl methacrylate was used for the monomer, benzoin methyl ether was used for the photoinitiator, and polyvinyl alcohol was used as an additive.

2. Composition Example of a UV Crosslinkable Acrylic Copolymer Transparent Insulative Adhesive Material

| Component | Example | | | | |
|---|---|---|---|---|---|
| (Weight %) | 1 | 2 | 3 | 4 | 5 |
| Acrylate | 80.0 | 75.0 | 73.0 | 70.0 | 65.0 |
| Monomer | | | | | |
| Photoinitiator | 15.0 | 19.0 | 22.0 | 25.0 | 30.0 |
| Initiator | 4.5 | 4.5 | 4.0 | 4.5 | 3.0 |
| Solvent | 0.5 | 1.5 | 1.0 | 0.5 | 2.0 |

2-ethylhexyl acrylate was used for the acrylate monomer, C-36 was used for the photoinitiator, AIBN was used for the initiator, and ethyl acetate was used for the solvent.

3. Composition Example of a Thermally Curable Silicone Elastic Polymer's Main Ingredient

| Component | | Example | | | | |
|---|---|---|---|---|---|---|
| (Weight %) | | 1 | 2 | 3 | 4 | 5 |
| Main | Component A | 65.0 | 61.0 | 62.0 | 63.0 | 63.0 |
| Ingredient | Component B | 32.0 | 34.0 | 31.0 | 33.0 | 35.0 |
| (Base | Component C | 3.0 | 5.0 | 7.0 | 4.0 | 2.0 |
| Material) | | | | | | |

Dimethyl siloxane was used for component A, dimethylvinylated was used for component B, and tetrasilane was used for component C.

4. Composition Example of a Thermally Curable Silicone Elastic Polymer's Curing Agent

| Component | | Example | | | | |
|---|---|---|---|---|---|---|
| (Weight %) | | 1 | 2 | 3 | 4 | 5 |
| Curing | Component A | 45.0 | 50.0 | 55.0 | 40.0 | 43.0 |
| Agent | Component B | 25.0 | 20.0 | 22.0 | 28.0 | 27.0 |
| | Component C | 23.0 | 25.0 | 15.0 | 26.0 | 21.0 |
| | Component D | 7.0 | 5.0 | 8.0 | 6.0 | 9.0 |

Dimethyl was used for component A, dimethylvinyl-terminated was used for component B, dimethylvinylated was used for component C, and tetrasilane was used for component D.

5. Composition Ratio between the Thermally Curable Silicone Elastic Polymer's Main Ingredient and Curing Agent

A composition ratio between the main ingredient and the curing agent, with regard to weight %, of 10:1 enabled suitable use for a touch panel. Side ingredients were selectively used only when there was a need to adjust the viscosity or thermal stability.

FIG. 5 is a cross-sectional view of a resistive-film type touch-sensitive sheet according to an embodiment of the present invention. The touch-sensitive sheet 60-2 may be structured to have a transparent insulative adhesive film 25, in which conductive balls 23 and ball spacers 27 are mixed, formed over a base film 61, an upper/lower plate adhesive film 41 located along the edges on both sides of the transparent insulative adhesive film 25, and a releasing paper 63 adhered over the transparent insulative adhesive film 25 and the upper/lower plate adhesive film 41. The upper/lower plate adhesive film 41 may serve to adhere the upper plate and lower plate which form the touch panel. Thus, it is not necessary that the upper/lower plate adhesive film 41 have a transparent quality, but in this embodiment of the invention, a transparent insulative adhesive film 25 with the conductive balls 23 is used for the upper/lower plate adhesive film 41. While ball spacers 27 are mixed into the upper/lower plate adhesive film 41 to more correctly maintain the distance between the upper and lower plates of the touch panel, it is obvious that other tools for maintaining distance can be inserted. When the same material is used for the transparent insulative adhesive film 25 and the upper/lower plate adhesive film 41, the adhesive strength for both will be the same, so that the resistance between different materials which can occur at the interface can be removed.

FIG. 6 is a cross-sectional view of a resistive-film type plate-integrated touch-sensitive sheet according to an embodiment of the present invention. The plate-integrated touch-sensitive sheet 70 may be structured to have a transparent upper plate 11, an upper contact electrode 13 patterned on the transparent upper plate 11, a wiring electrode 14 patterned on certain areas of the upper contact electrode 13, a transparent insulative adhesive film 25 having conductive balls 23 and ball spacers 27 mixed therein that is adhered onto the upper contact electrode 13, an upper/lower plate adhesive film 41 adhered onto the transparent upper plate 11 and the upper contact electrode 13 along both edges of the transparent insulative adhesive film 25, and a releasing paper 63 adhered over the transparent insulative adhesive film 25 and the upper/lower plate adhesive film 41. The transparent upper plate 11, which may serve as the upper plate of a touch panel, can be made of a suitable arbitrary material, and may generally be electrically highly insulated compared to conductive layers. Materials such as a flexible plastic sheet or film, rigid plastic, and others can be used. In many applications, the touch panel is used as an overlay to a display device, and hence, it may be preferable for the plate to be substantially transmissive with respect to visible rays. In other applications, graphic images, text, or other indicators may be provided between the use and the touch panel, and in these applications, it may not be necessary to use a transparent material.

The upper contact electrode 13 provides an electrode that enables visibility in applications where a display or other object is viewed through the touch panel. Various transparent conductive oxides, such as tin oxide, indium tin oxide (ITO), antimony tin oxide (ATO), etc., as well as various conductive polymers, such as polypyrrole, polyaniline, polyacetylene, polythiophene, polyphenylene vinylene, polyphenylene sulfide, poly(p-phenylene), polyheterocycle vinylene, and polyethylenedioxythiophene can be used for the upper contact electrode 13, where a resistance of 300 to 500Ω□ may be preferable.

The wiring electrode 14 is an electrode for supplying power to the upper contact electrode 13 or detecting power supplied to the upper contact electrode 13. Conductive metals, semimetals, doped semiconductors, conductive metal oxides, organic metals, conductive polymers, etc., can be used for forming the wiring electrode 14, where silver (Ag) is used especially often.

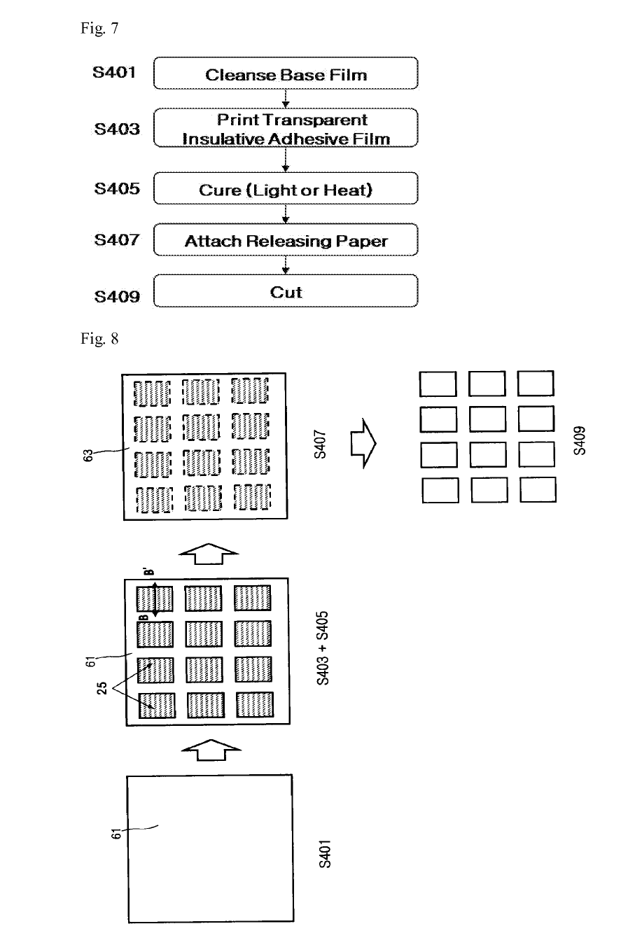

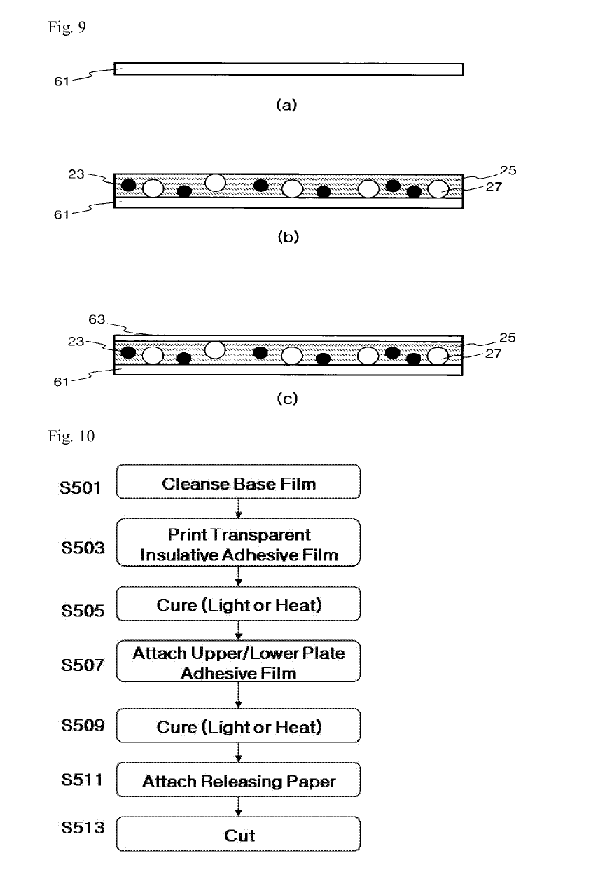

FIG. 7 is a flow diagram of a process for manufacturing the resistive-film type touch-sensitive sheet shown in FIG. 4, FIG. 8 is a process diagram as seen from above, and FIG. 9 is a process diagram as seen as a cross-sectional view across line B-B′ of FIG. 8. First, the base film 61 may be cleansed (S401, FIG. 9(a)), and a transparent insulative adhesive material, having a viscosity of 500 to 20,000 CP (centipoises) to prevent flowing, may be printed or coated over the base film 61 (S403, FIG. 9(b)). A viscosity of 1,000 to 10,000 CP may be preferable. The printing method can include inkjet printing, screen printing, stencil printing, imprinting, and offset printing, etc., while the coating technique can include typical, well-known methods such as roll coating, knife coating, gravure coating, die coating, reverse coating, etc. Of course, a web process, known for manufacturing cellophane tape, can preferably be used also. Next, the transparent insulative adhesive material may be cured using light or heat, to form a transparent insulative adhesive film 25 (S405). Whereas the transparent insulative adhesive material is in a liquid state before curing, it may turn into a gel-state film 25 after curing. After adhering the releasing paper 63 on the cured transparent insulative adhesive film 25 (S407, FIG. 9(c)), the arrangement may be cut into individual cells (S409) to complete the manufacture.

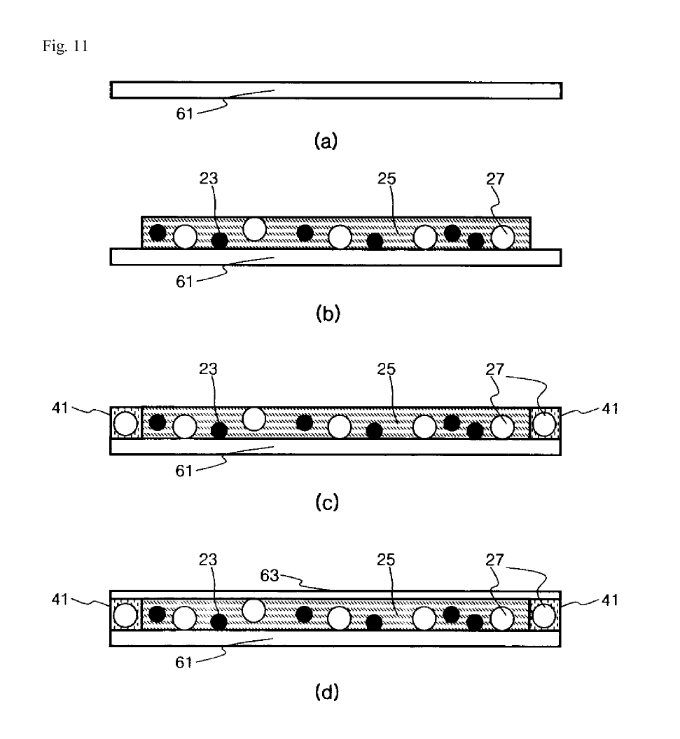

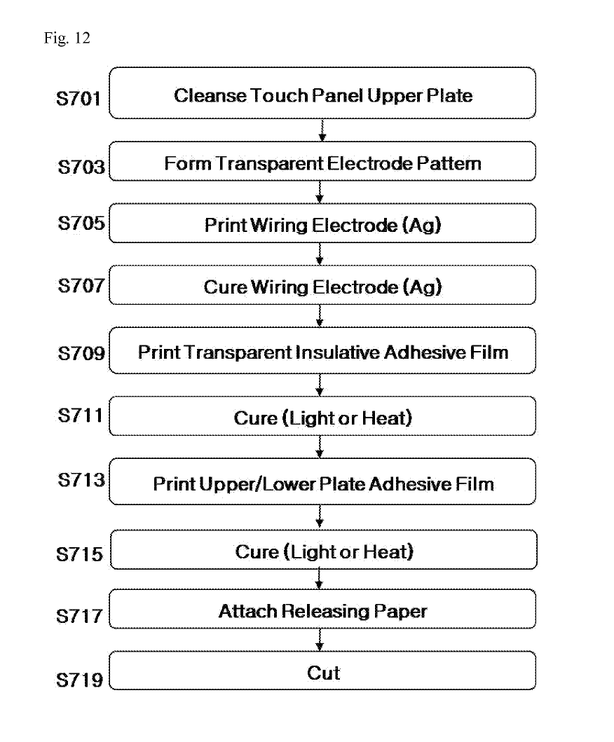

FIG. 10 is a flow diagram of a process for manufacturing the resistive-film type touch-sensitive sheet shown in FIG. 5, and FIG. 11 is a process diagram as seen as a cross-sectional view. First, the base film 61 may be cleansed (S501, FIG. 11(a)), and the transparent insulative adhesive material in a liquid state may be formed over the base film 61 (S503). Next, the transparent insulative adhesive material may be cured using light or heat, to form a transparent insulative adhesive film 25 (S505, FIG. 11(b)). Whereas the transparent insulative adhesive material is in a liquid state before curing, it may turn into a gel-state film 25 after curing. Next, an upper/lower plate adhesive material may be printed in the edge areas of the transparent insulative adhesive film 25 (S507) and then cured to form the upper/lower plate adhesive film 41 (S509, FIG. 11(c)). In an embodiment of the invention, the upper/lower plate adhesive material may be made of substantially the same material as the transparent insulative adhesive material, or more accurately put, the transparent insulative adhesive material with the conductive balls 23 removed. After adhering the releasing paper 63 on the cured transparent insulative adhesive film 25 and the upper/lower plate adhesive film (S511, FIG. 11(d)), the arrangement may be cut into individual cells (S513) to complete the manufacture.

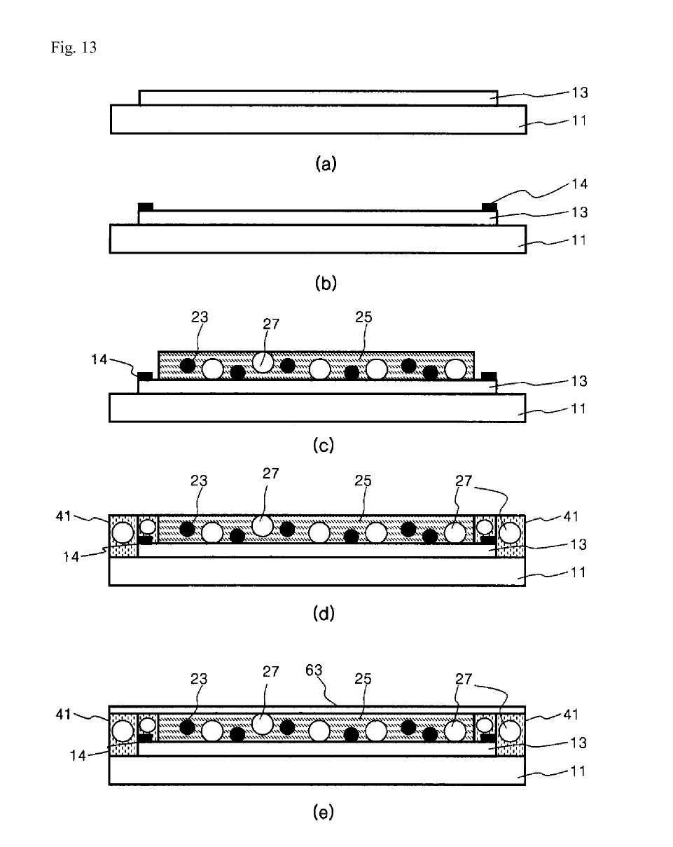

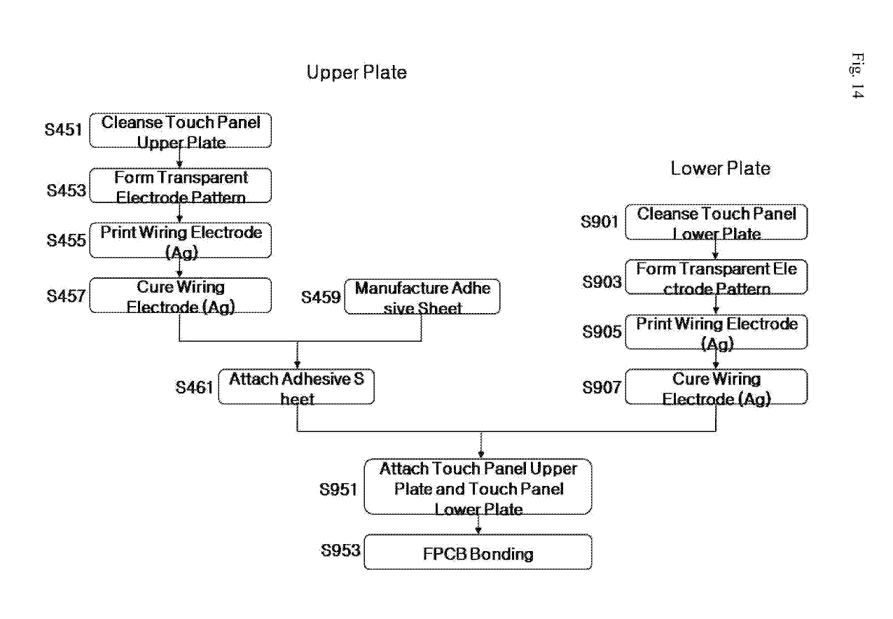

FIG. 12 is a flow diagram of a process for manufacturing the resistive-film type plate-integrated touch-sensitive sheet shown in FIG. 6, and FIG. 13 is a process diagram as seen as a cross-sectional view. The upper transparent plate 11 for the touch panel may be cleansed (S701), and the upper contact electrode 13 may be patterned over the transparent plate 11 (S703, FIG. 13(a)). Next, the wiring electrode 14 may be printed in certain areas of the upper contact electrode 13 and then cured (S705, S707, FIG. 13(b)). The transparent insulative adhesive material in a liquid state may be formed over the upper contact electrode 13 (S709), and the transparent insulative adhesive material may be cured using light or heat to form the transparent insulative adhesive film 25 (S711, FIG. 13(c)). Whereas the transparent insulative adhesive material is in a liquid state before curing, it may turn into a gel-state film 25 after curing. Next, an upper/lower plate adhesive material may be printed in the edge areas of the transparent insulative adhesive film 25 (S713) and then cured to form the upper/lower plate adhesive film 41 (S715, FIG. 13(d)). In an embodiment of the invention, the upper/lower plate adhesive material may be made of substantially the same material as the transparent insulative adhesive material, or more accurately put, the transparent insulative adhesive material with the conductive balls 23 removed. After adhering the releasing paper 63 on the cured transparent insulative adhesive film 25 and the upper/lower plate adhesive film (S717, FIG. 13(e)), the arrangement may be cut into individual cells (S719) to complete the manufacture.

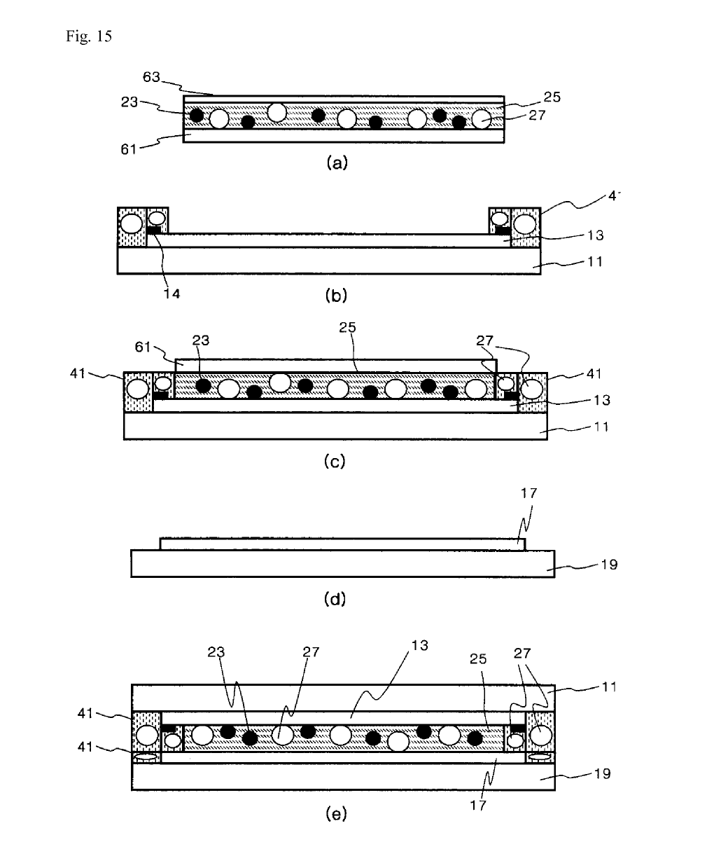

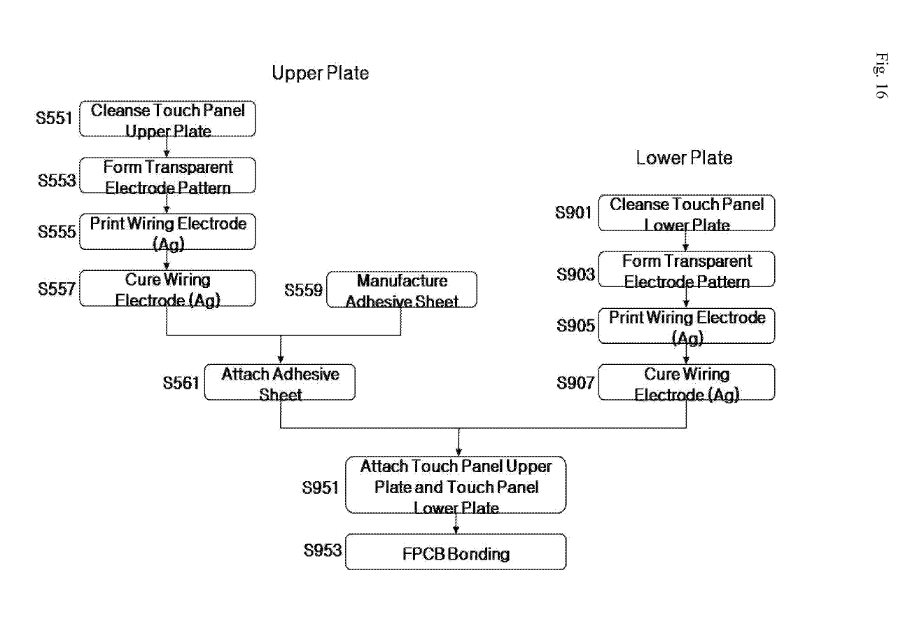

FIG. 14 is a flow diagram of a process for manufacturing a touch panel using a touch-sensitive sheet formed by the process shown in FIG. 7, and FIG. 15 is a process diagram as seen as a cross-sectional view. First, a description will be provided on the process for manufacturing the upper plate for the touch panel. The touch-sensitive sheet may be manufactured according to the process shown in FIG. 7 (S459, FIG. 15(a)), while the remaining portions of the touch panel's upper plate may be manufactured by a separate process. The remaining portions of the touch panel's upper plate may be completed (FIG. 15(b)) by cleansing the touch panel's upper plate 11 (S451), patterning the upper contact electrode 13 (S453), printing (S453) the wiring electrode 14 over at least a portion of the upper area of the upper contact electrode 13 and curing (S457), and forming the upper/lower plate adhesive film 41. Next, the releasing paper 63 of the touch-sensitive sheet may be removed, and the arrangement may be adhered to the upper contact electrode 13 on the touch panel's upper plate (S461, FIG. 15(c)).

The lower plate for the touch panel may be manufactured in a separate process from that of the touch panel's upper plate. The lower plate for the touch panel may be cleansed (S901), and the lower contact electrode 17 may be patterned over the lower plate (S903). A wiring electrode may be printed on the patterned lower contact electrode 17 (S905) and cured (S907, FIG. 15(d)) to complete the lower plate. The wiring electrode is not illustrated in FIG. 15(d).

The base film 61 may be removed from the upper plate illustrated in FIG. 15(c), the lower plate manufactured by a separate process may be attached (S951), and a flexible printed circuit board (FPCB) may be bonded (S953) to complete the touch panel.

While the upper plate and lower plate for the touch panel are described as being attached by the upper/lower part adhesive film 41 for the examples shown in FIG. 14 and FIG. 15, it is obvious that an attachment tape, such as that used in attaching upper plate and lower plate for a touch panel according to the related art, can also be used if necessary.

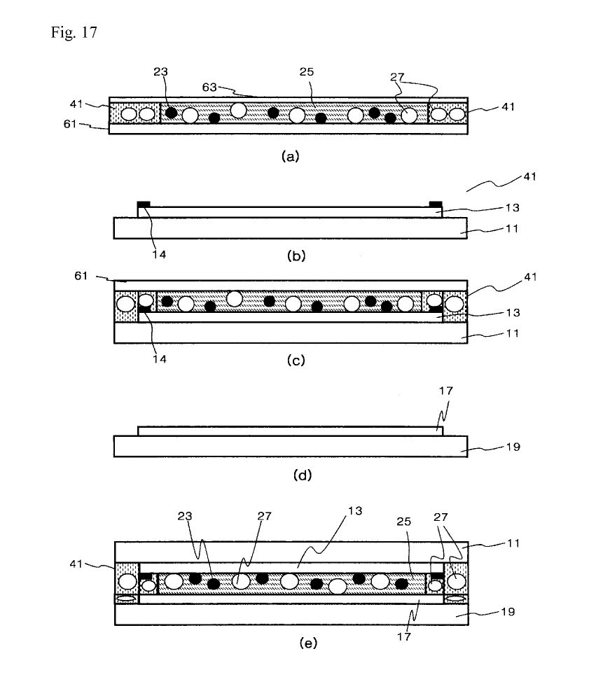

FIG. 16 is a flow diagram of a process for manufacturing a touch panel using a resistive-film type plate-integrated touch-sensitive sheet formed by the process shown in FIG. 12, and FIG. 17 is a process diagram as seen as a cross-sectional view. First, a description will be provided on the process for manufacturing the upper plate for the touch panel. The touch-sensitive sheet may be manufactured according to the process shown in FIG. 10 (S559, FIG. 17(a)), while the remaining portions of the touch panel's upper plate may be manufactured by a separate process. The remaining portions of the touch panel's upper plate may be completed (FIG. 17(b)) by cleansing the touch panel's upper plate 11 (S551), patterning the upper contact electrode 13 (S553), and printing the wiring electrode 14 over at least a portion of the upper area of the upper contact electrode 13 and curing (S555 and S557). Next, the releasing paper 63 of the touch-sensitive sheet may be removed, and the arrangement may be adhered to the upper contact electrode 13 on the touch panel's upper plate (S561, FIG. 17(c)).

The lower plate for the touch panel may be manufactured in a separate process from that of the touch panel's upper plate. The lower plate for the touch panel may be cleansed (S901), and the lower contact electrode 17 may be patterned over the lower plate (S903). A wiring electrode may be printed on the patterned lower contact electrode 17 (S905) and cured (S907, FIG. 17(d)) to complete the lower plate. The wiring electrode is not illustrated in FIG. 17(d).

From the upper plate illustrated in FIG. 17(c), the base film 61 may be removed, the lower plate manufactured by a separate process may be attached (S951), and a flexible printed circuit board (FPCB) may be bonded (S953) to complete the touch panel (FIG. 17(e)).

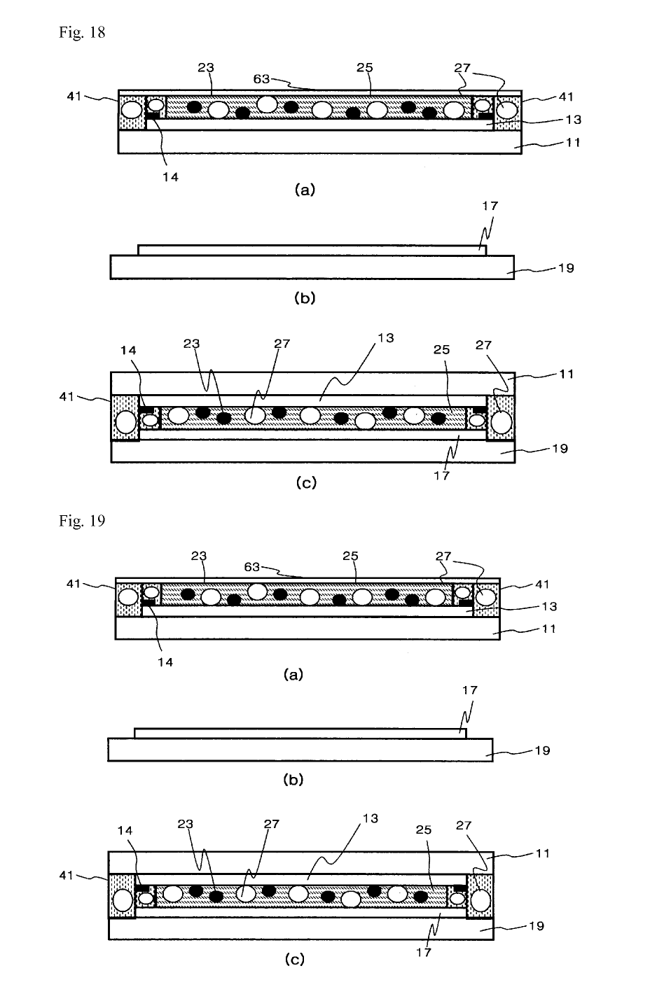

FIG. 18 is a flow diagram of a process for manufacturing a touch panel using a resistive-film type plate-integrated touch-sensitive sheet formed by the process shown in FIG. 12, and FIG. 19 is a process diagram as seen as a cross-sectional view. The plate-integrated touch-sensitive sheet may be manufactured according to the process shown in FIG. 12 (S751, FIG. 19(a)).

The lower plate for the touch panel may be manufactured by a separate process from that for manufacturing the upper plate for the touch panel. The touch panel's lower plate may be cleansed (S901), and the lower contact electrode 17 may be patterned thereon (S903). A wiring electrode may be printed on the patterned lower contact electrode 17 (S905) and cured (S907, FIG. 19(b)) to complete the lower plate. The wiring electrode is not illustrated in FIG. 19(b).

From the upper plate illustrated in FIG. 19(a), the releasing paper 63 may be removed (S7530, the lower plate manufactured by a separate process may be attached (S951), and a flexible printed circuit board (FPCB) may be bonded (S953), to complete the touch panel.

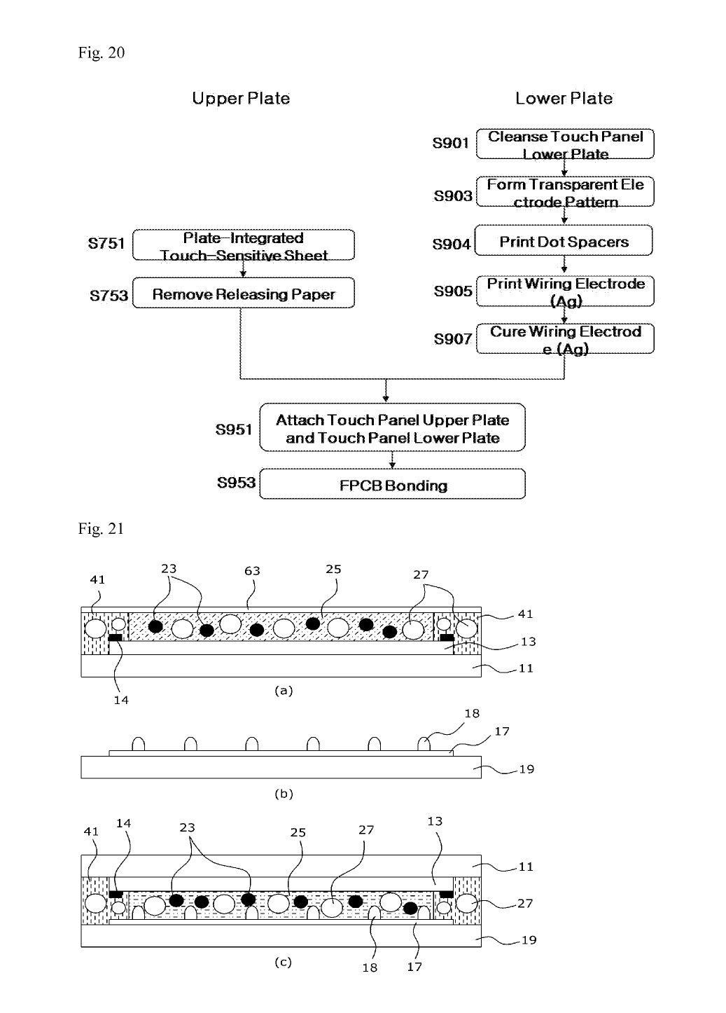

The embodiment illustrated in FIG. 20 and FIG. 21 is similar to the embodiment illustrated in FIG. 18 and FIG. 19, respectively, except that dot spacers are formed on the lower plate forming the touch panel. As such, the description for FIG. 20 and FIG. 21 will be provided only for the processes that are different from those of FIG. 18 and FIG. 19.

In the process for manufacturing the lower plate, between step S903 and step S905, after the transparent electrode pattern is formed in step S903, dot spacers 18 may be formed thereover from a non-conductive material as illustrated in FIG. 21(b). Since, in the embodiment of FIG. 20 and FIG. 21, there are dot spacers 18 present, it may be preferable to remove the ball spacers 27 from the transparent insulative adhesive film 25. The height of the dot spacers formed here may desirably not exceed about ½ of the cell gap between the upper plate and lower plate. If the height of the dot spacers exceeds ½ of the cell gap, the user may not easily press the desired point.

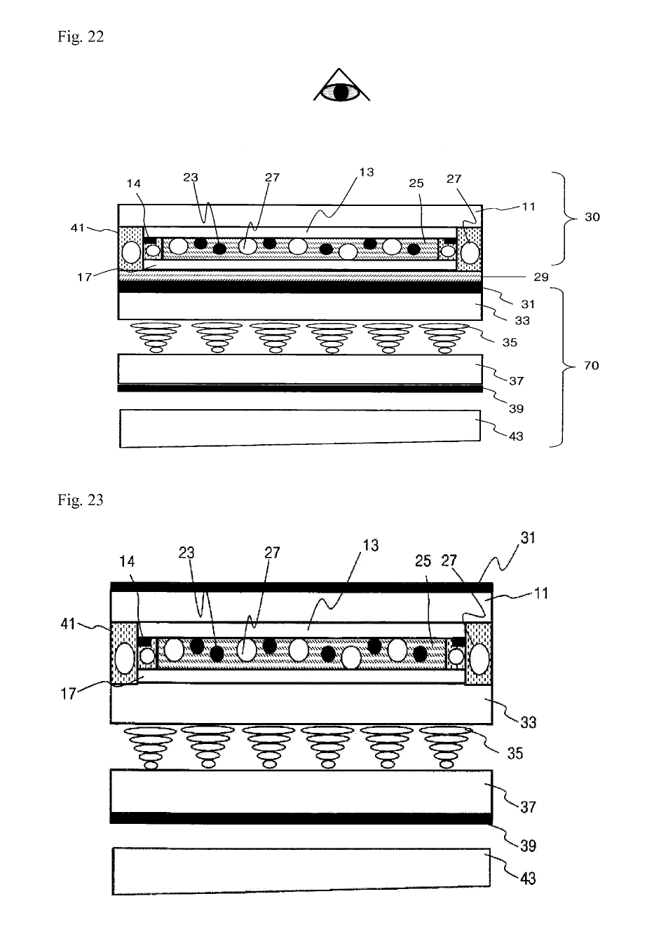

FIG. 22 is a cross-sectional view of a display device to which a touch-sensitive sheet according to an embodiment of the present invention has been applied. A touch screen display device of an embodiment of the invention may be structured to have a touch panel 30 attached over a display element 70 using a transparent adhesive 29. Since the entire surface of the upper polarizing plate 31, which is attached to the upper transparent plate 33 of the display element 70, is attached to the entire surface of the lower plate 19 of the touch panel 30 by the transparent adhesive 29, the display element 70 and the touch panel 30 can maintain a uniform attachment distance, and air gaps found in attachment methods according to the related art can be removed. While the illustration in FIG. 22 shows the display element 70 and the touch panel 30 being attached by the transparent adhesive 29 only, dot spacers or ball spacers can be mixed into the transparent adhesive 29 as necessary, either regularly or irregularly, to maintain a uniform distance between the display element 70 and the touch panel 30. Here, the dot spacers may be formed on the attachment surface of the display element 70.

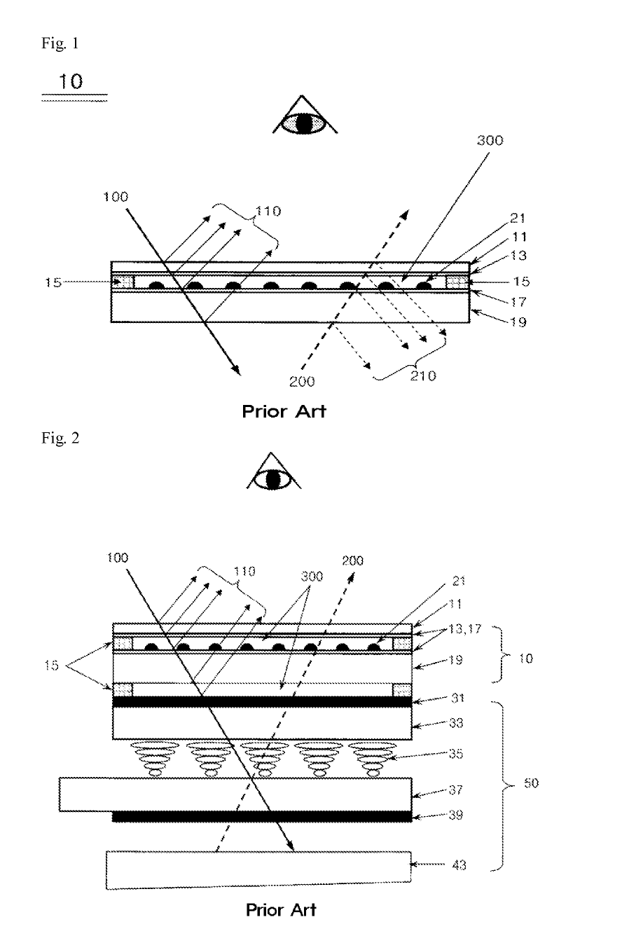

A liquid crystal display element, an organic EL element, a field emission element, an electrophoresis element including electronic ink, etc., having a planar form can be used for the display element 70. Also, while FIG. 22 illustrates an example in which a touch panel 30 based on an embodiment of the invention is used, it is obvious that the transparent adhesive 29 can be used to attach a resistive-film type touch panel 30 based on the related art, such as that illustrated in FIG. 1, to a display element 70.

If a liquid crystal display element is used for the display element 70, the structure of the liquid crystal display element may include a lower transparent plate 37 having a lower polarizing plate 39 attached to an upper transparent plate 33 having an upper polarizing plate 31, with liquid crystal 35 injected into the attached space of the two plates, and with a backlight unit 43 located below the lower transparent plate 37.

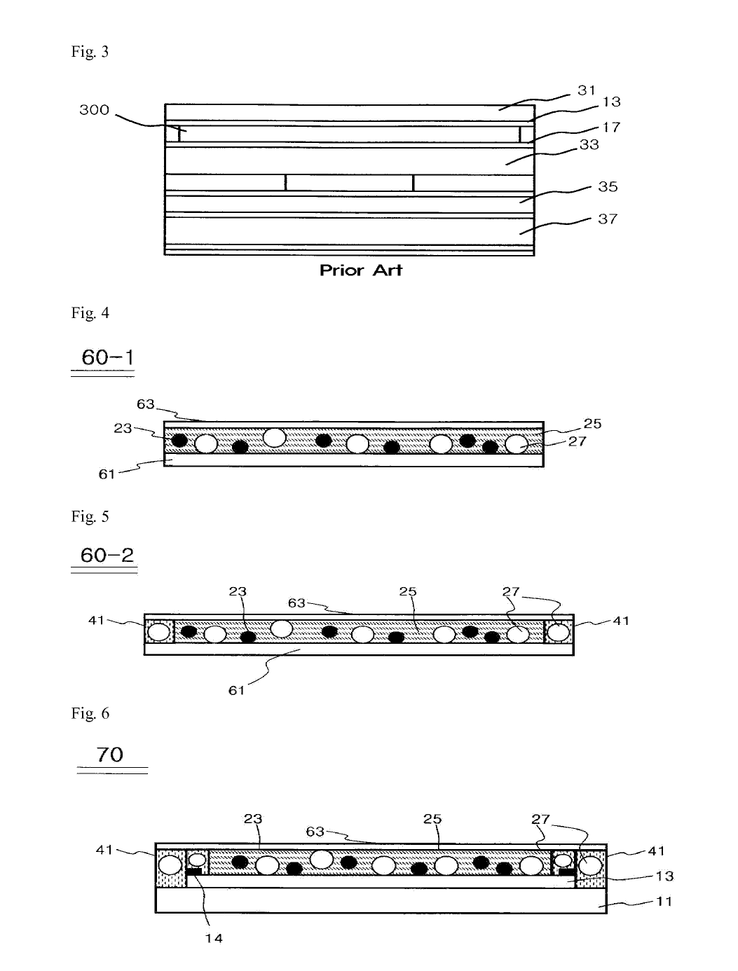

FIG. 23 is a cross-sectional view of a display device to which a touch-sensitive sheet according to an embodiment of the present invention has been applied. In the touch-sensitive display device of FIG. 23, the air gaps found in a conventional touch-panel-integrated liquid crystal display device such as that illustrated in FIG. 3 are removed. The touch-sensitive display device of FIG. 23 may include a touch-sensitive component located between the upper polarizing plate 31 and upper transparent plate 33 forming the liquid crystal display element.

A lower transparent plate 37 is included, below which is a backlight unit 43 and above which is a lower transparent plate 37 having a lower polarizing plate 39 attached thereto. An upper transparent plate 33 is located in a position facing the lower transparent plate 37, and over that is the lower contact electrode 17 for the touch panel. At a position facing the lower contact electrode 17 is the upper contact electrode 13, and above that is the upper polarizing plate 31. The upper contact electrode 13 and the lower contact electrode 17 facing each other may be entirely adhered by way of the transparent insulative adhesive film 25 having conductive balls 23 mixed therein. Liquid crystal 35 is injected between the lower transparent plate 37 and the upper transparent plate 33. Of course, ball spacers and/or dot spacers can be mixed into the transparent insulative adhesive film 25 in addition to the conductive balls 23. Since the conductive balls 23 mixed in the transparent insulative adhesive film 25 allow an entire adherence between the upper contact electrode 13 and the lower contact electrode 17, the air gaps found in attachment methods according to the related art can be removed.

While the spirit of the invention has been described above with reference to particular embodiments, it is apparent that the skilled person can practice various modifications without departing from the spirit of the invention. It is to be understood that such modified embodiments are not separate from the spirit and scope of the invention, but are encompassed by the scope of the appended claims.

1. A touch-sensitive sheet used for manufacturing a resistive-film type touch panel, the touch-sensitive sheet comprising:
a base film;
a transparent insulative adhesive film located over the base film, the transparent insulative adhesive film having conductive balls mixed therein; and
a releasing paper adhered over the transparent insulative adhesive film.

2. A plate-integrated touch-sensitive sheet used for manufacturing a resistive-film type touch panel, the touch-sensitive sheet comprising:
an upper plate for the touch panel;
an upper contact electrode patterned on the upper plate;
a transparent insulative adhesive film located over the upper plate and the upper contact electrode, the transparent insulative adhesive film having conductive balls mixed therein; and
a releasing paper adhered over the transparent insulative adhesive film.

3. The touch-sensitive sheet according to either one of claim 1 and claim 2, wherein the transparent insulative adhesive film further comprises ball spacers mixed therein, the ball spacers have a diameter smaller than or equal to a thickness of the transparent insulative adhesive film, and the conductive balls have a diameter smaller than the diameter of the ball spacers.

4. The touch-sensitive sheet according to either one of claim 1 and claim 2, wherein the transparent insulative adhesive film has an adhesive strength according to ASTM D3330 measurement standards of 50 to 10,000 gf/in.

5. The touch-sensitive sheet according to either one of claim 1 and claim 2, wherein the transparent insulative adhesive film is formed of an acrylic copolymer or a silicone elastic polymer which is cured by UV curing or thermal curing.

6. The touch-sensitive sheet according to either one of claim 1 and claim 2, wherein the transparent insulative adhesive film is made of an acrylic copolymer or a silicone elastic polymer.

7. The touch-sensitive sheet according to claim 6, wherein the acrylic copolymer is a photo-radical polymerizable type or a photo-cationic polymerizable type.

8. A method of manufacturing a touch-sensitive sheet used for manufacturing a resistive-film type touch panel, the method comprising:
a first step of forming a base film;
a second step of forming a transparent insulative adhesive material over the base film, the transparent insulative adhesive material having conductive balls mixed therein;
a third step of forming a transparent insulative adhesive film by curing the transparent insulative adhesive material using heat or UV rays; and
a fourth step of adhering a releasing paper over the transparent insulative adhesive film.

9. A method of manufacturing a plate-integrated touch-sensitive sheet used for manufacturing a resistive-film type touch panel, the method comprising:
a first step of cleaning/preparing an upper plate for the touch panel and patterning an upper contact electrode on the upper plate;
a second step of forming a transparent insulative adhesive material over the upper plate and upper contact electrode, the transparent insulative adhesive material having conductive balls and ball spacers mixed therein;
a third step of a transparent insulative adhesive film by curing the transparent insulative adhesive material using heat or UV rays; and
a fourth step of adhering a releasing paper over the transparent insulative adhesive film.

10. The method according to either one of claim 8 and claim 9, wherein the transparent insulative adhesive material of the second step is formed using a printing technique selected from a group consisting of inkjet printing, screen printing, stencil printing, imprinting, and offset printing techniques.

11. The method according to either one of claim 8 and claim 9, wherein the transparent insulative adhesive material of the second step is formed by a gravure coating technique or a web process.

12. The method according to either one of claim 8 and claim 9, wherein the transparent insulative adhesive material is a material forming an acrylic copolymer or a silicone elastic polymer which is cured by UV curing or thermal curing.

13. A resistive-film type touch panel comprising an upper plate having an upper contact electrode pattern-deposited thereon and a lower plate having a lower contact electrode pattern-deposited thereon, wherein the upper plate and the lower plate are attached over an entire surface by way of a transparent adhesive, the transparent adhesive having conductive balls mixed therein.

14. The method according to claim 13, wherein the transparent adhesive has ball spacers mixed together therein, the ball spacers having a diameter smaller than a height of the transparent adhesive.

15. The method according to claim 13, further comprising dot spacers on the lower contact electrode.

16. The method according to claim 13, wherein the transparent adhesive has a refractive index equal to or within a range of 0.1 from a refractive index of the upper plate.
